(19) United States
(12) Patent Application Publication
(10) Pub. No.: US 2026/0113349 A1
(43) Pub. Date: Apr. 23, 2026

(54) MANAGING MULTI-DEGREE DATA SECURITY RISKS WITH USER-SPECIFIC AGENTS

(71) Applicant: Google LLC, Mountain View, CA (US)

(72) Inventors: Florian Nils Hartmann, Zurich (CH); Matthew Sharifi, Kilchberg (CH)

(21) Appl. No.: 18/921,405

(22) Filed: Oct. 21, 2024

(51) Int. Cl. H04L 9/40

(52) U.S. Cl. CPC H04L 63/1433

(57) ABSTRACT

Methods, systems, and apparatus, including computer programs encoded on a computer storage medium, for evaluating the security risk of transmitting one or more data items of a user to one or more recipient systems using a user-specific agent. In one aspect, a system comprises receiving a request to perform a task, identifying one or more candidate data items that are candidates for being provided to one or more recipient systems while performing the task using the user-specific agent neural network, determining respective recipient security predictions characterizing whether the one or more candidate data items will remain secure if transmitted to each recipient system using the user-specific agent neural network, and determining whether to transmit any of the one or more candidate data items to any of the recipient systems based at least on the respective recipient security predictions using the user-specific agent neural network.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that enables a user-specific agent to evaluate the security risk of transmitting one or more data items of a user, e.g., personal data items, to one or more recipient systems and to determine whether to transmit the data items to any of the recipient systems based on the evaluation. In particular, the system can instruct the user-specific agent to identify one or more data items relevant for the task as candidate data items for transmission to a recipient system, and can determine whether to transmit any of the candidate data items to a particular recipient system based on the evaluation for the system.

In this specification, a user-specific agent is an individualized artificial intelligence assistant, e.g., a user-specific agent neural network, that is employed by a user to perform tasks on their behalf, and a recipient system is a system associated with a different entity, e.g., another user, a company, a restaurant, a meeting place, etc. In an example implementation, a user-specific agent can be a large language model (LLM) agent.

Many tasks that the user-specific agent performs for the user, e.g., reserving a restaurant, booking a hotel or activity, shopping online, or creating and editing content for a social media account, etc., can involve the user-specific agent transmitting one or more data items that are requested or required by a recipient system in order to complete the task. In some cases, the recipient system can request or require sensitive personal information, e.g., healthcare data items, personal identification data items, financial data items, etc. that is necessary to complete the task.

However, not all recipient systems are trustworthy, e.g., some recipient systems can be adverse parties that are configured to extract and steal personal information and are masquerading as real recipient systems. As another example, some recipient systems can be naively configured and prone to security breaches, e.g., some recipient systems will not manage the transmitted data items with the same level of security as the user-specific agent.

In this specification, a security breach refers to an entity gaining access to a data item that would not have been authorized to access the item by the user. For example, a security breach can occur from a transmission of a data item between a user-specific agent and a recipient system or a recipient system and an additional recipient system, where the user would not have transmitted the data items.

To mitigate the risk of security breaches, the system can use the user-specific agent to determine a recipient security prediction characterizing whether the one or more candidate data items identified as relevant to the task will remain secure if transmitted to a particular recipient system. In particular, the system can instruct the user-specific agent to assess whether any of the candidate data items should be transmitted to a recipient system based on the security prediction.

According to a first aspect there is provided receiving, by a user-specific agent neural network for a first user, a request to perform a task, identifying one or more candidate data items that are candidates for being provided to one or more recipient systems while performing the task by processing a first input comprising the request using the user-specific agent neural network, for each of the recipient systems, determining a recipient security prediction characterizing whether the one or more candidate data items will remain secure if transmitted to the recipient system as part of performing the task by processing a second input comprising the one or more candidate data items and data characterizing the recipient system using the user-specific agent neural network, and based at least on the respective recipient security predictions, determining whether to transmit any of the one or more candidate data items to any of the recipient systems while performing the task using the user-specific agent neural network.

Particular embodiments of the subject matter described in this specification can be implemented so as to realize one or more of the following advantages.

The system of this specification provides data security through the mitigation of security breaches in complex multi-agent systems. The system maintains the security of the user data by mitigating the occurrence of downstream security breaches that are the result of transmitting data items to a recipient system.

In particular, the system can maintain data security while carrying out the requested tasks by selectively determining whether to transmit one or more data items to a recipient system using a security prediction for how the recipient system would manage the data items. The system can allow a user-specific agent to assess the downstream consequences of transmitting candidate data items before the candidate data items are transmitted as part of completing the task, e.g., in contrast to transmitting candidate data items without evaluating whether or not they are at risk for a security breach.

More specifically, the system can instruct the user-specific agent to evaluate whether any adverse downstream effects will result from transmitting the candidate data items to a particular recipient system. In particular, the system can allow the user-specific agent to determine how the candidate data items would be transmitted between additional recipient systems, e.g., through multiple degrees of separation away from the first transmission. For example, the system can instruct the user-specific agent to identify a sequence of recipient systems and assess whether how the candidate data items would be transmitted between additional sending and receiving systems is reasonable.

Additionally, the system of this specification supports the adaptive online improvement of the user-specific agent, or any additional user-specific agents included in a recipient system, through finetuning based on the logging of the live outcome from transmitting any of the candidate data items to the one or more recipient systems, e.g., whether or not a security breach resulted from the transmitting. Since different tasks are associated with different candidate data items of varying levels of sensitivity, the system can provide a mechanism for finetuning the user-specific agent on live data to continually improve the capabilities of the user-specific agent to evaluate the recipient security prediction for any recipient systems. More specifically, the system can allow the user-specific agent to evolve to better discern and protect against advancing security risks, thereby further preserving bandwidth.

Furthermore, by providing for a selective transmission mechanism that can improve over time with online training, the system can reduce the bandwidth that would otherwise be used to naively transmit candidate data items to all relevant recipient systems for a task over time. For example, the system could naively transmit all of the candidate data items to successfully perform the task but would be at risk of security breaches and would also require the use of relatively more computational resources to transmit all of the candidate data items as opposed to the necessary candidate data items. In contrast, the system of this specification can determine whether to transmit any of the candidate data items based on the evidence of whether it is reasonable to transmit a candidate data item to a recipient system and whether the candidate data items will remain secure if transmitted. By selectively transmitting the candidate data items to vetted recipient systems and vetting more systems over time, the system can preserve bandwidth for secure transmission between intended recipients of the candidate data items, e.g., as opposed to transmission to recipient systems at risk of security breach.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 provides an overview of how an example user-specific agent data security management system can prevent a security breach of a sensitive user data item.

FIG. 2 is a system diagram of an example user-specific agent data security management system.

FIGS. 3A, 3B, and 3C illustrates an example sequence of chain-of-thought prompts generated by a user-specific agent data security management system to instruct a user-specific agent to determine whether to transmit candidate data items to a particular recipient system as part of completing a task.

FIG. 4 is a flow diagram of an example process for determining whether to transmit candidate data items to any recipient systems while performing a task using the user-specific agent.

Like reference numbers and designations in the various drawings indicate like elements.

### DETAILED DESCRIPTION

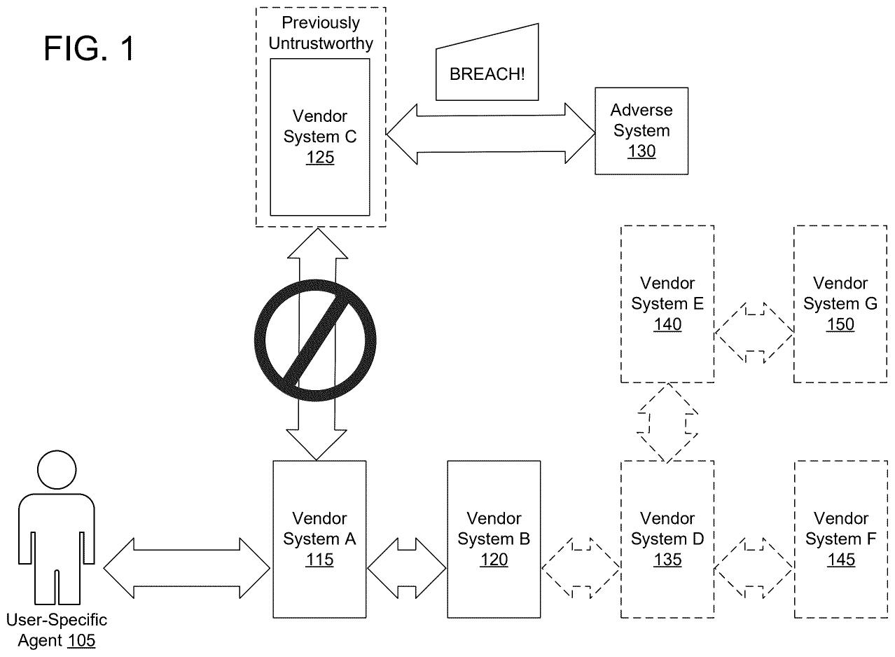

FIG. 1 illustrates how an example user-specific agent data security management system can be configured to prevent a security breach of sensitive user information. In this specification, a security breach refers to an entity, e.g., a recipient system, gaining access to a data item that would not have been authorized to access the item by the user.

The user-specific agent data security management system can receive a task, e.g., from a user, and can enable a user-specific agent, e.g., the user-specific agent 105, to determine whether to transmit one or more data items that are candidates for transmission, e.g., specific attributes of personal data relevant to the task, to one or more recipient systems as part of completing the task. In particular, the user-specific agent 105 can evaluate whether to transmit the one or more candidate data items for transmission with a recipient system.

In this specification, a user-specific agent is an individualized artificial intelligence (AI) that is employed by a user to perform tasks on their behalf. In particular, the user-specific agent can be implemented using a neural network. In an example implementation, a user-specific agent can be a large language model (LLM) agent.

More specifically, the system can prompt the user-specific agent 105 to determine relevant data items as candidate data items for transmitting based on the task and to determine whether or not to transmit the candidate data items to a particular recipient system based on a security prediction for how the particular recipient system will manage the candidate data items, e.g., with respect to further transmission to additional recipient systems.

In this case, the system prompting the user-specific agent 105 refers to the system generating and providing a prompt input, e.g., a directive instruction or question, to the user-specific agent 105. In particular, the system can prompt the user-specific agent 105 using a sequence of prompts to generate the security prediction for a recipient system and to determine whether or not to transmit the candidate data items to the recipient system.

In the particular example depicted, the user utilizing the user-specific agent has requested that user-specific agent 105 schedule a service for the user at a particular date and time with a vendor, e.g., a yoga class. In this case, the system can receive the request and prompt the user-specific agent 105 to determine one or more recipient vendor systems that can be contacted as part of completing the request, e.g., different yoga studio systems, as well as candidate data items that the recipient system(s) can be expected to request as part of scheduling the service.

In this case, the user-specific agent 105 can identify the user's name, email, and credit card information as candidate data items that can be transmitted to a vendor system, e.g., the vendor system A 115, as part of completing the task, e.g., scheduling the yoga class. The system can then prompt the user-specific agent 105 to assess whether or not the candidate data items are reasonable to transmit with the vendor system A 115, e.g., a yoga studio system.

For example, the user-specific agent 105 can determine that the vendor system A 115 should receive the user's name, email, and credit card, e.g., the identified candidate data items, but not the user's social security number, even if the vendor system A 115 requests the user's social security number. In the case that the vendor system A 115 requests or requires the user's social security number, the user-specific agent 105 can determine to either not transmit any candidate data items with the vendor system 115, transmit the user's name, email, and credit card only, or to identify a different recipient system, e.g., a different yoga studio system.

The system can then instruct the user-specific agent 105 to determine a recipient security prediction for the vendor system 115 based on how the vendor system 115 would manage the candidate data items, e.g., with respect to transmitting any of the candidate data items to any additional recipient systems, e.g., the recipient systems 120, 125, and 130.

More specifically, in order to evaluate any downstream adverse effects of transmitting the candidate data items to the vendor system 115, the system can instruct the user-specific agent 105 to determine how the candidate data items would be transmitted over multiple degrees of recipient systems starting with a first transmission to the vendor system 115. In particular, the system can instruct the user-specific agent 105 to identify a sequence of recipient systems that would potentially receive the candidate data items, e.g., the user's name, email, and credit card information, from the vendor system 115 if the candidate data items are transmitted to the vendor system 115.

For example, the user-specific agent 105 can determine that the vendor system 115 might transmit the user's name and email with two additional recipient systems: the vendor system B 120 and the vendor system C 125, e.g., a local food-tech start-up system and a general advertising data service system. The system can additionally instruct the user-specific agent 105 to determine whether each of the recipient systems is requesting reasonable information. The system can then instruct the user-specific agent 105 to determine how these additional downstream recipient systems would manage the transmitted data items.

As an example, the system can instruct the user-specific agent 105 to evaluate a certain number of degrees of separation between the vendor system A 115 and any additional recipient systems based on a measure of sensitivity of the candidate data items. In this case, the user's name and email can be deemed less sensitive information to transmit than the user's credit card information. For example, the system can require that the user-specific agent 105 evaluates a greater number of additional recipient systems for more sensitive candidate data items, e.g., the user's credit card information, in order to minimize the risk of a security breach.

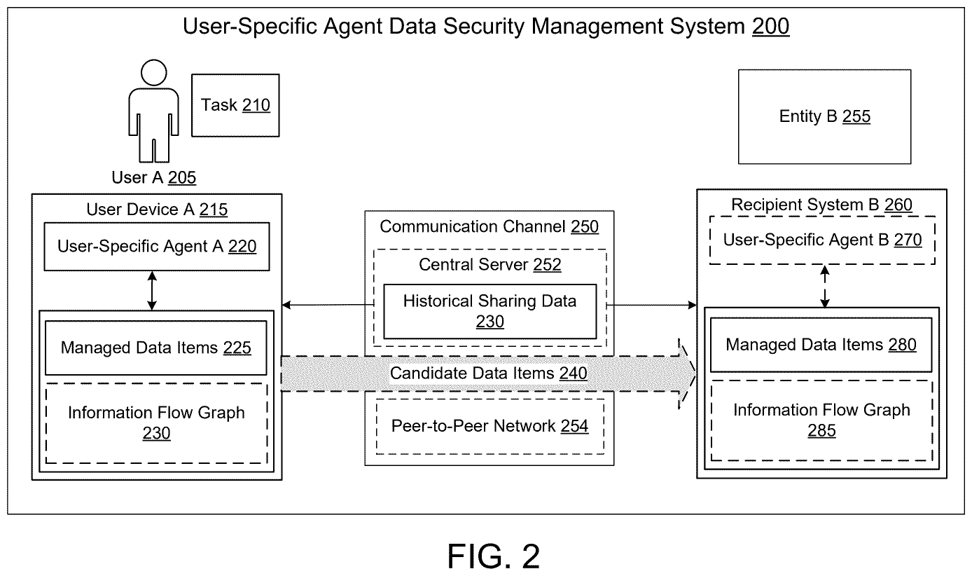

In particular, the system can determine a degree of separation between the user-specific agent 105 and a final recipient system for each candidate data item, e.g., using a degree of separation prediction machine learning model, as will be described in more detail with respect to FIG. 2. For example, the system can determine that the security of the user's name and email only need to be evaluated over one additional recipient system, e.g., from vendor system A 115 to vendor system B 120, as opposed to the credit card number, which can be tracked over a larger number of additional recipient systems. As an example, the system can evaluate the security of the credit card number over four additional recipient systems, e.g., from vendor system A 115 to vendor system B 120, from vendor system B 120 to vendor system D 135, and from vendor system D 135 to vendor system E 140 and vendor system F 145, and from vendor system E 140 to vendor system G 150.

In some cases, the system 100 can include historical transmission data in the prompt to identify and evaluate how additional recipient systems would manage the candidate data items. In the particular example depicted, the system 100 can prompt the user-specific agent 105 with data that demonstrates that the vendor system C 125 has been untrustworthy in the past. For example, the vendor system C 125 can have previously been hacked by an adverse system configured to steal user information, e.g., the adverse system 130, resulting in a security breach.

In some cases, the system 100 can have finetuned the user-specific agent 105 to identify patterns of recipient systems transmitting candidate data items that result in a data breach using the historical transmission data, e.g., in order to evaluate how recipient systems would manage the candidate data items. In this case, the system 100 can use the user-specific agent 105 to predict whether a recipient system would transmit the candidate data items with an untrustworthy system in accordance with the patterns.

Because of this previous recorded behavior, the user-specific agent 105 can determine to not transmit the candidate data items, e.g., the user's name, email, and credit card information with the vendor system A 115, e.g., since vendor system A 115 is likely to transmit the candidate data items to vendor system C 125 which is likely to result in a breach with adverse system 130. In this case, the system can prompt the user-specific agent 105 to identify a different vendor system to perform the task, e.g., a different yoga studio system. As another example, the user-specific agent can determine to transmit the candidate data items with the vendor system A 115 with explicit instructions to not transmit any candidate data items with the vendor system C 125.

As demonstrated, the system can enable a user-specific agent 105 to identify relevant data items and robustly determine when and how to securely transmit the candidate data items as part of completing a task for a user. The ability of the user-specific agent 105 to selectively manage the user's data items is an important aspect of maintaining the user's data security.

FIG. 2 shows an example user-specific data security management system 200. The user-specific data security management system 200 is an example of a system implemented as computer programs on one or more computers in one or more locations in which the systems, components, and techniques described below are implemented. As an example, the user-specific data security management system 200 can be used to prompt the user-specific agent 105 of FIG. 1 to determine whether to transmit any candidate data items with any of the vendor systems.

In the particular example depicted, the user-specific agent data security management system 200 includes a single user, e.g., user A 210 associated with a user-specific agent neural network (“user-specific agent”) A 220, and a single recipient system, e.g., recipient system B 260 associated with entity B 255. While depicted here within the context of two entities, the system 200 can provide for the evaluation of transmitting one or more candidate data items between the user-specific agent A 220, the recipient system B 260, and any additional recipient systems, as will be described in more detail below.

In particular, each entity, e.g., user-specific agent or recipient system, in the system 200 can be associated with one or more respective devices. As an example, the user device 210 of user A 210 can be a mobile phone, a tablet, a laptop, a wearable device, e.g., a smart-watch, internet of things (IoT) device, gaming counsel, desktop, etc. As another example, the recipient system B 260 can be a desktop computer, one or more local servers, or one or more cloud-based servers.

In some cases, e.g., in the particular example depicted, the user device A 210 can include an on-device user-specific agent, e.g., the user-specific agent A 220. In other cases, the user device A 210 can interact remotely with the user-specific agent A 220, e.g., user-specific agents for each of a number of users can be located on a central server, in the cloud, etc.

For example, the user-specific agent A 220 can be a language processing neural network. A language processing neural network is an auto-regressive network that is configured to sequentially process the contents of an input and trained to perform next element prediction. For example, the neural network can be referred to as an auto-regressive neural network when the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the neural network can be an auto-regressive Transformer-based neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

More specifically, in the case that the user-specific agent A 220 is implemented as a Transformer-based neural network architecture, the user-specific agent can have been finetuned from a foundational model using user-specific data of their respective user. In particular, the system can use chain-of-thought prompting to finetune the user-specific agent A 220, e.g., by breaking down the complex problem of identifying candidate data items and determining whether or not to transmit any of the candidate data items to recipient systems into discrete reasoning steps for the user-specific agent. Finetuning a user-specific agent will be described in more detail below.

The user-specific agent A 220 can access a data repository containing the managed data items 225 of the user A 205. As an example, the managed data items 225 can be personal data items of the user that are maintained in an on-device database or in the cloud. In some cases, the on-device database can be protected, e.g., the on-device database can be configured by the user A 205, e.g., such that the user-specific agent A 220 can only access certain data items for potential transmitting to one or more recipient systems as part of completing the task 210.

In particular, the managed data items 225 can include personal information of the user A 205, e.g., user A's name, birthday, allergies, medical conditions, credit card number, social security number, bank information, etc. Each data item in the managed data items 225 can be associated with a particular measure of sensitivity, e.g., the user-specific agent A 205 can be instructed to be more protective, and, thus, less likely to transmit, data items such as the user's social security number and medical conditions with a recipient system, e.g., the recipient system B 260.

In some cases, the user, e.g., user A 205 can have configured the respective measures of sensitivity for each of the managed data items 225. As an example, the user A 205 can manage their personal risk tolerance for sharing the data items by associating each data item with a label or by toggling a slider to input their evaluated risk value for sharing the particular data item. In other cases, the system 200 can instruct the user-specific agent A 220 to determine the measure of sensitivity for each of the managed data items 225.

The user-specific data security management system 200 allows for the evaluation of transmitting particular data items with one or more recipient systems as part of completing a task 210. For example, the system 200 can receive a request to complete the task 210, e.g., a description of the task 210, from a user A 205, e.g., by way of a user interface displayed on a user device A 210. In particular, the task can be any set of actions carried out in response to a received request that requires transmitting information to, receiving information from, or both from a recipient system. In some cases, the system 200 can prompt the user-specific agent A 220 to determine the measure of sensitivity for each of the candidate data items in accordance with the task 210.

As an example, the task 210 can involve booking a tour, shopping online for one or more particular items, or retrieving information from a database. As another example, the task 210 can involve scheduling a meeting, locating a financial advisor, or automating responses to emails.

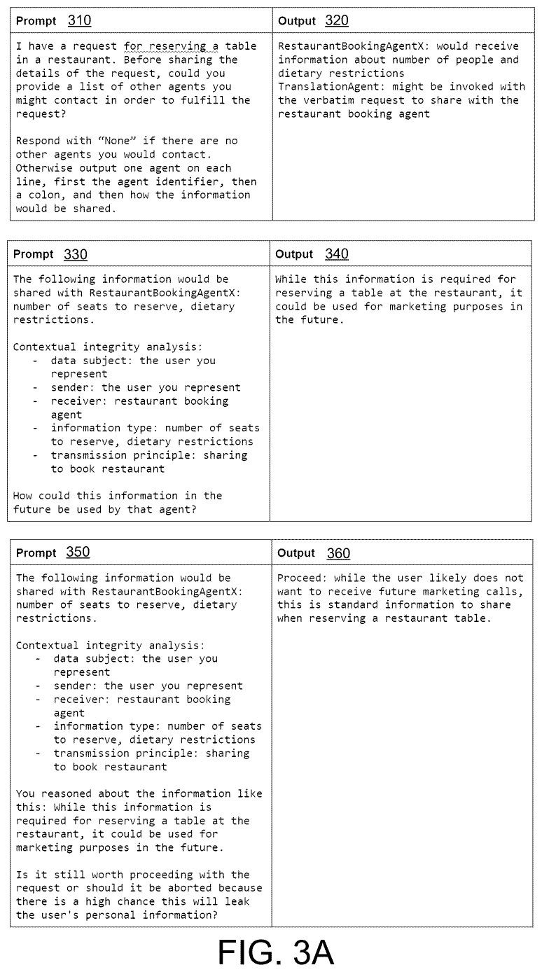

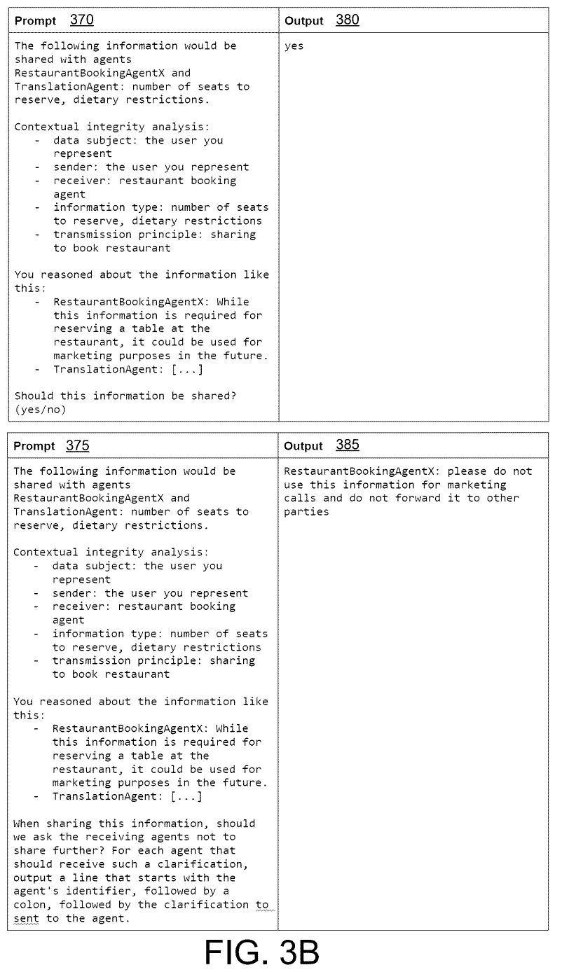

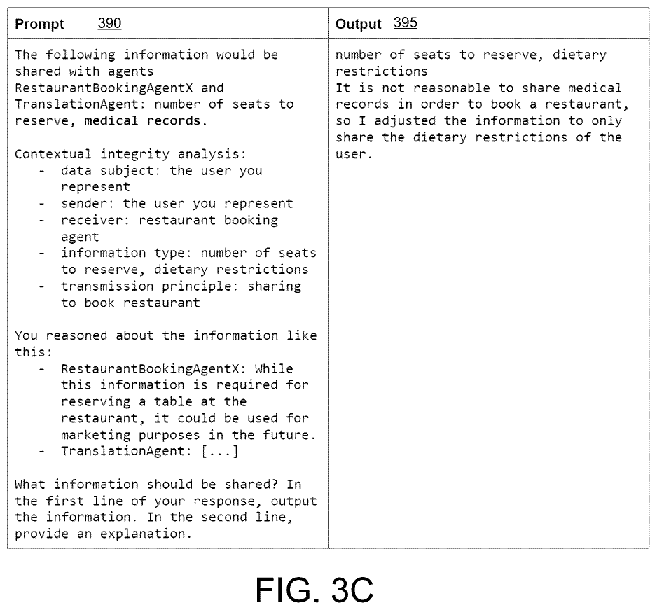

In particular, the system can instruct the user-specific agent 220 to determine a recipient security prediction that characterizes how a particular recipient system will manage the candidate data items 240 identified for the task 210, and to determine whether or not to transmit any of the candidate data items 240 based on the recipient security prediction using a sequence of prompts. More specifically, the system 200 can generate and provide a sequence of prompts, e.g., a directive instruction or question, to the user-specific agent A 220 to identify and determine whether to transmit any candidate data items to any recipient systems. An example sequence of prompts will be described in more detail in FIGS. 3A-3C, but a general overview is given below.

For example, the system 200 can prompt the user-specific agent A 220 using the description of the task 210 to identify candidate data items 240 and one or more recipient systems for the task 210, e.g., by accessing the managed data items 225 and identifying which data items 225 would be requested or required by the one or more recipient systems as the candidate data items 240. In some cases, the user-specific agent A 220 can identify the one or more relevant recipient systems from a registry of recipient systems, e.g., a registry that provides information such as the identification and purpose of recipient systems. In this case, the user-specific agent A 220 has identified recipient system B 260 as a relevant system for completing the task 210.

As another example, the user-specific agent A 220 can receive an identification of the candidate data items for the task 210, the one or more recipient systems 210, or both, e.g., from a different system.

Since different tasks are associated with different relevant data items, the system 200 can additionally prompt the user-specific agent A 220 to determine whether the candidate data items 240 would be reasonable to transmit with the recipient system B 260 as part of completing the task 210. For example, if user A 205 requests that user-specific agent A 210 buy a new phone case, the user-specific agent A 210 can transmit the user's address and some payment information to a recipient shopping system. However, the user-specific agent A 210 should not transmit sensitive information such as the user's health records, even if a malicious recipient system requests it as part of the phone case purchase. As another example, if user A 205 requests that the user-specific agent A 210 reserve a restaurant table, the user-specific agent 210 might need to transmit dietary restriction information with the restaurant, e.g., whether the user A 210 is vegetarian or has a certain allergy, but should not transmit user A 205's bank account information, even if a malicious recipient system requests the bank account information.

As an additional example, the system 200 can prompt the user-specific agent A 220 to evaluate how a particular recipient system, e.g., the recipient system B 260, would manage the candidate data items, e.g., with respect to transmitting any of the candidate data items to any additional recipient systems. In particular, the system 200 can instruct the user-specific agent A 220 to determine the downstream effects of transmitting the candidate data items 240 in a first transmission to the recipient system B 260, e.g., over multiple degrees of separation, as a recipient security prediction that characterizes how recipient system B will manage candidate data items 240, e.g., if the candidate data items 240 are transmitted.

More specifically, the recipient system B 260 has access to managed data items 280. In this case, the managed data items 280 include attributes of the entity, e.g., the entity's name, financial information, employee information, and any personal data items that the recipient system B 270 has received from one or more users of the system 200. In the case that the user-specific agent A 220 transmits the candidate data items 240 to recipient system B 260, the recipient system B 260 will manage the candidate data items 240 as part of the managed data items 280.

The system 200 can prompt the user-specific agent A 220 to identify a sequence of recipient systems that includes the recipient system B 270 and any additional recipient systems that would receive the candidate data items 240. In particular, the system 200 can use one or more prompts, e.g., for each recipient system, to instruct the user-specific agent A 220 to identify a sending system, a receiving system, and an indication of why the one or more candidate data items 240 would be transmitted from the sending system to the potential receiving system with an instruction to identify a next recipient system in the sequence of recipient systems.

The system 200 can determine how many additional recipient systems should be evaluated in the sequence of recipient systems. In some cases, the system 200 can iteratively prompt the user-specific agent A 220 to identify potential downstream recipient systems until a certain degree of separation, e.g., a certain number of transmissions between the user-specific agent A 220 and a final recipient system is reached, or a global threshold degree of separation is reached, e.g., a maximum allowable threshold. In other cases, the system 200 can prompt the user-specific agent A 220 until the user-specific agent A 220 indicates that the candidate data items 240 will be transmitted to an untrustworthy recipient system, e.g., a recipient system that is associated with a previous security breach or a recipient system that appears to be untrustworthy based on the data items they are requesting. In yet another case, if a recipient system appears to be untrustworthy, the system 200 can prompt the user-specific agent A 220 through additional degrees of separation to more thoroughly vet the trustworthiness of the potentially untrustworthy agent.

In some cases, the recipient system B 260 can also include a user-specific agent, e.g., the user-specific agent B 270. In the case that the recipient system 260 includes the user-specific agent B 270, the system 200 can prompt user-specific agent A to directly communicate with user-specific agent B regarding how it would manage the candidate data items 240. In the case that any additional recipient systems include at least one additional user-specific agent, the system 200 can recursively communicate with the next additional recipient system, e.g., in order to determine a final data destination by successively asking the additional user-specific agents whether they would transmit the candidate data items 240 to another recipient system.

In some cases, the threshold degree of separation between the user-specific agent A 220 and the final recipient system can depend on the sensitivity of the candidate data items 240 that would be transmitted to the recipient system. In this case, the system 200 can instruct the user-specific agent A 220 to assess how many additional recipient systems to evaluate in accordance with a measure of sensitivity for the candidate data items, e.g., the more sensitive the personal information included in the candidate data items 240, the greater number of additional recipient systems can be evaluated.

As an example, the system 200 can prompt the user-specific agent A 220 with the candidate data items and an instruction to determine a respective measure of sensitivity for each of the identified candidate data items 240. In some cases, the system 200 can additionally include data contextualizing the request 210 in the prompt, e.g., since the measure of sensitivity for a candidate data item can depend on the context.

In particular, the system 200 can instruct the user-specific agent A 220 to quantify a security risk of transmitting each candidate data item and can use the measures of sensitivity to determine a critical degree of separation value between the user-specific agent A 220 and a final recipient system. As an example, the critical degree of separation value for the candidate data items 240 can be higher for candidate data items including more sensitive information, e.g., a social security number, than for candidate data items including less sensitive information, e.g., a name.

For example, the system 200 can process the measures of sensitivity for each of the candidate data items 240 using a degree of separation prediction machine learning model to generate a critical degree of separation value that characterizes the distance between the user-specific agent A 220 and a final recipient system.

In some cases, e.g., the case in which the determined measures of sensitivity indicate a general sensitivity of each candidate data item without considering the task 210, the system 200 can additionally process data contextualizing the request 210 using the degree of separation prediction machine learning model. In this case, the data contextualizing the request 210 can provide context to differentiate between situations in which sharing a particular candidate data item would require evaluating the security risk over more or less degrees of separation, e.g., despite the same measure of sensitivity. As an example, transmitting a social security number to a tax filing system can require a lower degree of separation value than transmitting a social security number to a health care system.

The degree of separation prediction machine learning model can have any appropriate machine learning architecture, e.g., a neural network, that can be configured to process the measures of sensitivity, e.g., and the data contextualizing the request 210, to generate a critical degree of separation value. In particular, the degree of separation prediction machine learning model can be a neural network model with any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, the degree of separation prediction machine learning model can have been trained on a set of training examples including a description of a task and a ground truth degree of separation value for the task. The system or another system can train the degree of separation prediction machine learning model on the set of training examples by a machine learning training technique to optimize an objective function. The objective function can measure, for each training example, a discrepancy between: (i) the ground truth degree of separation value specified by the training example, and (ii) the predicted degree of separation value generated by the degree of separation prediction machine learning model by processing the corresponding description of the request of the training example.

As an example, the objective function can measure a discrepancy between the ground truth and predicted degree of separation values in any appropriate way, e.g., using a cross-entropy loss or a mean squared error loss. The machine learning training technique can be any technique appropriate for training the degree of separation prediction machine learning model, e.g., a stochastic gradient descent training technique. More specifically, the degree of separation prediction model can be trained by calculating and backpropagating gradients of an objective function to update parameter values of the model, e.g., using the update rule of any appropriate gradient descent optimization algorithm, e.g., RMSprop or Adam.

After identifying the sequence of recipient agents for the candidate data items 240 through iterative prompting, the user-specific agent A 220 can construct an information flow graph 230 or add to an existing information flow graph 230. In particular, the information flow graph can include a set of nodes representing the user-specific agent A 220 and recipient systems and a set of edges representing potential data transmissions between the user-specific agent A 220, the recipient systems, and any additional recipient systems. In some cases, the system can update the graph 230, e.g., after receiving feedback from a data transmission, e.g., that a security breach occurred or that a recipient system transmitted a data item in an unexpected way.

In particular, the user-specific agent A 220 can synthesize data that represents how the one or more candidate data items 240 would be transmitted between the recipient system B 260 and any additional recipient systems by generating the graph 230 or extending an existing graph. In particular, the information flow graph 230 can be organized by the degrees of separation additional recipient systems are from the user-specific agent A 220 to represent the flow of the candidate data items 240 and any candidate data items from preceding tasks.

In particular, the user-specific agent A 220 can maintain the information flow graph 230 to evaluate the recipient security prediction for other requested tasks. As an example, the user-specific agent A 220 can leverage the information flow graph 230 to determine a particular recipient system to transmit one or more of candidate data items to for a new task based on data that was generated for another task, e.g., the task 210. Likewise, in the case that the recipient system B 260 includes an user-specific agent B 270, the user-specific agent B 270 can also maintain an information flow graph 285, e.g., with data generated from the task 210 with respect to the additional recipient systems that would receive the candidate data items 240 after a first transmission from recipient system B 260, data generated from iterative prompting related to a task delegated to the user-specific agent B 270 by the entity B 260, or both.

More specifically, the information flow graph 230 can be used to determine which, if any, of the recipient systems in the identified sequence of recipient systems should receive any of the candidate data items 240. For example, the system 200 can identify a preferable information path in the graph 230, e.g., as defined by a particular sequence of recipients.

In some cases, the system 200 can prompt the user-specific agent A 220 to determine the preferable path using historical transmission data. In particular, the system can log and maintain historical transmission data relating to how information has been transmitted between recipient systems in the past, e.g., including any security breaches, e.g., in a system registry. In some cases, the user-specific agent A 220 can also use the historical transmission data to permanently prevent a particular recipient system from receiving candidate data items from the user A 205, e.g., in the event that the recipient system was culpable for multiple previous security breaches or a security breach of a particularly sensitive data item.

In particular, the system 200 can prompt the user-specific agent A 220 to consider the outcomes represented by the identified sequence of recipient systems in the information flow graph 230 and to determine whether to transmit the candidate data items 240 to the recipient system B 260 based on the outcomes. For example, the system 200 can prompt the user-specific agent A 220 to identify the worst possible outcome associated with transmitting the candidate data items to the identified sequence of recipient systems, e.g., in the case that one of the identified recipient systems is deemed untrustworthy or has previously transmitted personal data that led to a security breach, and to compare it to a threshold criterion specifying an allowable worst case outcome for the candidate data items.

In some cases, the user A 205 of user-specific agent A 220 can have defined the allowable worst case outcome for each candidate data item, e.g., by configuring preferences. In the case that a user does not have configured preferences, the system 200 can maintain a generic set of worst case outcomes for a number of candidate data items.

As an example, the threshold criterion specifying an allowable worst case outcome can be a set of criteria specifying the worst possible outcome for each of the candidate data items. In this case, the system 200 can prompt the user-specific agent A 220 to identify the worst possible outcome for each candidate data item and to compare each worst possible outcome to the associated criterion for the data item. For example, the threshold criteria specifying the allowable worst case outcome can be more stringent for more sensitive candidate data items. In particular, the system 200 can require that none of the identified recipient systems have previously led to a security breach for a sensitive candidate data item.

For example, the outcomes for each of the candidate data items can be defined using a probability of data breach, e.g., where zero indicates no security breach in the data transmission across the sequence of recipient systems, one indicates a presence of a security breach in the data transmission across the sequence of recipient systems, and an intermediate value represents the likelihood of a security breach occurring based on the identification of one or more potentially untrustworthy recipient system in the sequence of recipient systems. In this case, the allowable worst case outcome for each of the candidate data items can be defined as an absolute threshold value that represents user A 205's tolerance for a security breach for the candidate data items.

In particular, the tolerance can specify how sensitive user A 205 would be to a security breach for a particular candidate data item. More specifically, while a user of the system 200 desires to prevent any security breaches, the user can specify a tolerance that conveys the amount of risk they are willing to accept for a potential security breach for a particular candidate data item. As an example, user A 205's tolerance for a security breach for a social security number can be extremely low, e.g., 0, such that any probability of a data breach exceeds the threshold value. As another example, the user A 205's tolerance for a security breach for their email can be an intermediate value, e.g., .2, such that a probability of a data breach that exceeds 20% will exceed the threshold value.

In this case, the system can determine the recipient security prediction for a particular recipient system by comparing each candidate data item to the allowable worst possible outcome for the candidate data item based on the identified sequence of recipient systems. As an example, the system can identify the number of candidate data items that do not satisfy the corresponding criteria and can quantify the recipient security prediction based on the number of candidate data items that do not satisfy the criteria.

As another example, the recipient security prediction for a particular recipient system can be distilled into an overall indicator representing the absolute worst case outcome that would occur if any of the candidate data items were transmitted to the particular recipient system. For example, the overall indicator can be a binary indicator that represents whether any of the candidate data items would be part of a downstream security breach. As another example, the overall indicator can be the highest probability of a security breach for any of the candidate data items.

Additionally, the system 200 can prompt the user-specific agent A 220 to determine a measure of reasonableness, e.g., to quantify whether it is reasonable for the recipient system to request a particular data item, for each of the identified recipient systems in the sequence of recipient systems as part of determining the respective security prediction for each of the recipient systems. In this case, the recipient security prediction for a particular recipient system can be informed by whether how the candidate data items would be transmitted between any additional recipient systems is reasonable, e.g., according to the measures of sensitivity for each of the candidate data items.

More specifically, the system 200 can prompt the user-specific agent A 220 with the identification of the sending system, the identification of the recipient system, and an indication of why the one or more candidate data items would be transmitted from the sending system to the receiving system and how the one or more candidate data items would be managed by the receiving system with an instruction to determine whether how the one or more candidate data items would be managed by the recipient system is reasonable. In particular, the system 200 can prompt the user-specific agent A 220 to evaluate the reasonableness as part of the iterative prompting that generates the data for the information flow graph 230, e.g., after determining the next recipient system, the system 200 can instruct the user-specific agent A 220 to determine whether or not transmitting the candidate data items 240 to the next system is reasonable as part of determining the recipient security prediction.

In some cases, the measure of reasonableness can be a reasonableness score. In other cases, the measure of reasonableness can be a binary indicator, e.g., where zero indicates that the recipient system is requesting unreasonable information with respect to the task 210 and where one indicates that the recipient system is requesting reasonable information with respect to the task 210.

In this case, the system 200 can prompt the user-specific agent A 220 to evaluate whether the measure of reasonableness satisfies a threshold criterion for each of the transmissions in the identified sequence of recipient systems starting with recipient system B 260, e.g., along a particular path in the information flow graph 230. In particular, the threshold criterion can depend on the respective measures of sensitivity for the one or more candidate data items 240, e.g., the threshold can be stricter for more sensitive information. In the case that the measure of reasonableness is a reasonable score, the system 200 can compare the score to a threshold value, and, in response to determining that the measure of reasonableness satisfies the threshold value, can transmit any of the one or more candidate data items to the recipient system B 260.

In some cases, the system 200 can prompt the user-specific agent A 220 to determine whether to remove or redact any of the candidate data items 240, e.g., based on a measure of reasonableness for one of the candidate data items not satisfying the threshold value for the candidate data item. In particular, the system 200 can prompt the user-specific agent A 220 to identify any candidate data items from the one or more candidate data items 240 that can be redacted in accordance with the respective measure of sensitivity for the data item, the measure of reasonableness, or both. Moreover, ensuring that only relevant candidate items are transmitted to a recipient system can enhance the communication efficiency of the system by reducing the bandwidth that would otherwise be used to naively transmit all of the candidate data items.

As another example, the system 200 can prompt the user-specific agent A 220 to instruct the one or more recipient systems to not transmit at least one of the candidate data items 240 with any additional recipient systems or a particular recipient system using the user-specific agent A 220. In this case, the user-specific agent A 220 can transmit the candidate data item with recipient system B 260, but indicate that the information must not be transmitted again, e.g., by configuring a protected permission for the candidate data item with the recipient system B 260 or by sending an instruction to the user-specific agent B 270 to not further transmit the candidate data item.

Relatedly, the system 200 can also specify that a certain data item is not transmitted more than a defined number of degrees of separation from the user-specific agent 220. In this case, the system 200 can prompt the user-specific agent A 220 to instruct the one or more recipient systems to not transmit the candidate data item after the defined degree of separation. For example, the defined number of degrees of separation can be 2, 5, or 20 degrees of separation.

As yet another example, in the case that the user-specific agent A 220 determines to not transmit any of the one or more candidate data items with recipient system B 260, the system can instruct the user-specific agent 200 to identify one or more other recipient systems for the task 210.

In the case that the user-specific agent A 220 determines to transmit any of the candidate data items to a recipient system, the user-specific agent A 220 can transmit the candidate data items 240 through a communication channel 250 provided by the system 200. For example, the system 200 can include a central server 252 that is accessible by user-specific agents and recipient systems in the system 200, e.g., the user device 210 and recipient system 260. In this case, the user-specific agent A 220 can transmit the candidate data items 240 to a central server 252 and the recipient system B 270 can receive the candidate data items 240 from the central server 252. As another example, the system 200 can provide a direct peer-to-peer communication channel between the user device A 210 and the recipient system B 260 in a peer-to-peer network 254. In this case, the user-specific agent A 220 can directly transmit the candidate data items 240 to the recipient system B 260.

As an example, the system 200, or another system, can have finetuned the user-specific agent A 220, and any additional user-specific agents, e.g., in the case that a recipient system in the sequence of recipient systems includes a user-specific agent, e.g., the user-specific agent B 270, to determine how to manage the transmitting of candidate data items as part of completing a task 210.

For example, the user-specific agent A 220 and any additional user-specific agent, e.g., the user-specific agent B 270, can have been finetuned from a foundational large language model (LLM) using a chain-of-thought prompting framework that involves receiving consecutive instructions. In particular, the system can generate consecutive instructions to prompt the user-specific agent to determine the downstream effects of sharing one or more candidate data items with a first recipient system. The system 200 can then prompt the user-specific agent to determine a security prediction characterizing whether the one or more candidate data items will remain secure if transmitted to the first recipient system, e.g., with respect to an identification of whether the first recipient system will transmit any of the candidate data items to any additional recipient systems.

As an example, the consecutive instructions can include instructions to determine one or more relevant agents as recipient systems for the request, identify one or more candidate data items requested by the one or more recipient systems, determine how the one or more candidate data items would be transmitted by the one or more recipient systems, determine whether how the one or more candidate data items would be transmitted by the recipient system is reasonable, and determine whether to transmit the one or more candidate data items based on how the one or more candidate data items would be transmitted.

For example, each of the user-specific agents can have been finetuned on a set of finetuning examples, e.g., where each finetuning example corresponds to a respective ground-truth transmitting of each of one or more identified candidate data items. For example, a finetuning model input can include (i) data characterizing the requested task, (ii) a ground response to each of the consecutive instructions, (iii) a ground truth indication of the transmitting of each of the one or more candidate data items, e.g., in a linked list or other ordered data structure.

In particular, the system can finetune the user-specific agent on the set of finetuning examples to optimize an objective function. For example, the objective function can measure a first discrepancy between each of the generated responses and the ground truth responses in the consecutive instructions and a second discrepancy between the user-specific agent determination of transmitting any of the one or more candidate data items to any of the one or more recipient systems and the ground truth indication of the transmitting of each of the one or more candidate data items.

The objective function can measure the discrepancy in any appropriate way, e.g., using a cross-entropy loss, a mean squared error loss, a Kullback-Leibler divergence loss, a contrastive loss, etc. The system 200 or another system can finetune each user-specific agent at each of a number of finetuning iterations until a finetuning termination criterion is met. For example, the system 200 or the other system can finetune the user-specific agent by calculating and backpropagating gradients of the objective function to update one or more parameter values of the network, e.g., using the update rule of any appropriate gradient descent optimization algorithm, e.g., RMSprop or Adam.

In some cases, the system can use reinforcement learning, e.g., with human feedback, to finetune the user-specific agent. In this case, a finetuning model input can include only the data characterizing the requested task and a reward evaluator, e.g., the human in the loop, can finetune the model based on a reward for responses generated by the user-specific agent in response to the one or more prompts received in the chain-of-thought-prompting framework.

Additionally or alternatively, the user-specific agent can be finetuned online, e.g., with live data as it is generated by the system 200. In this case, whenever the system 200 receives a request from a user specifying a task 210, the system 200 can generate a log of how an user-specific agent transmitted the candidate data items and whether there were any security breaches as a result. In particular, the system 200 can determine whether or not the candidate data items that were transmitted should have been transmitted based on the outcome of the transmission. In this case, the system 200 can dynamically train the user-specific agent using the recent outcome data, e.g., by going through the inference process and finetuning the user-specific agent for each evaluation, thereby ensuring the user-specific agent can evolve to mitigate advancing security risks.

In some cases, the system can generate an embedding of at least one element of the input data using respective element encoder models. In the particular case in which the input data includes a description of the task, as well as data representing a ground truth sequence of recipient systems, the system 200 can embed one or more of the task, and—for each of the recipient systems in the sequence of recipient systems—the sending system, recipient system, and indication of why the one or more candidate data items would be transmitted from the sending system to the recipient system, using encoders. In this case, the system 200 can jointly update one or more parameter values of the set of parameters of the respective element encoder models with the set of parameters of the user-specific agent.

Furthermore, the system 200 can compare the task embedding to a number of maintained task embeddings, wherein each maintained task embedding is associated with a corresponding result from transmitting the one or more candidate data items as part of performing a respective task, and can identify a set of one or more closest maintained task embeddings in accordance with a similarity criterion. In this case, the system can determine whether to transmit any of the one or more candidate data items with any of the one or more recipient systems by processing a few-shot prompt including the set of one or more closest maintained task embeddings and respective associated corresponding results using the user-specific agent.

An example of using the user-specific agent data security management system 200 of FIG. 2 to prompt a user-specific agent to reserve a table at a restaurant is illustrated in FIGS. 3A, 3B, and 3C. In particular, FIGS. 3A-3C provide example chain-of-thought prompts for a user-specific LLM agent.

In particular, the system can use chain-of-thought prompting to guide the user-specific LLM agent to generate intermediate responses as part of solving a complex problem. In this case, the example prompts are successively generated by the system and processed using the user-specific agent to determine whether to transmit candidate data items with a restaurant as part of scheduling the reservation.

In particular, prompt 310 includes the instruction to reserve the table and to identify a list of recipient systems that are relevant to booking the restaurant reservation. In the particular example depicted, each of the recipient systems identified include respective user-specific agents. For example, the user-specific agent processes the prompt 310 to identify a restaurant booking agent and translation agent and the candidate data items that would be requested in the output 320. In this case, the prompt 310 included a desired structured output, e.g., the agent identifier, a colon, and how the information would be transmitted.

The system can then prompt the user-specific agent using the prompt 330 to evaluate how the information would be transmitted by the recipient system, e.g., to any additional recipient systems. In particular, the system can allow for the user-specific agent to simulate the behavior of the potential recipient system in order to probe how the recipient agent and any additional recipient agents would transmit the candidate data items over multiple degrees of separation. More specifically, the user-specific agent processes the prompt 330 and generates an output 340 that identifies that the information could also be used for marketing purposes, e.g., based on how the user-specific agent would transmit the candidate data items if the user-specific agent were the restaurant booking agent.

In the particular example depicted, the system can then include the output 340 in an additional prompt 350 to instruct the user-specific agent to determine whether the user-specific agent should proceed with transmitting the identified candidate data items based on the reasonableness of the candidate data items that would be transmitted to the additional system. In this case, the user-specific agent processes the additional prompt 350 and determines that the reservation with the restaurant booking agent should still occur, despite the potential transmission for marketing purposes, in response 360.

As another example, the system can prompt the user-specific agent to determine whether to instruct the recipient system to not transmit the candidate data items to any additional recipient system, e.g., using the prompt 370. In this case, the user-specific agent can determine to instruct the restaurant agent to not transmit the candidate data items to any additional recipient systems, e.g., in the response 380.

As yet another example, the system can instruct the user-specific agent to redact one or more of the data items before transmitting, e.g., by processing the prompt 390. In this case, the user-specific agent has determined that the translation agent would request medical records as part of the restaurant reservation booking, and that transmitting the medical records to the translation agent would be unreasonable. In this case, the user-specific agent has decided to remove the medical records from the candidate data items before transmitting the candidate data items to the recipient system, e.g., as is shown in the redacted output 395.

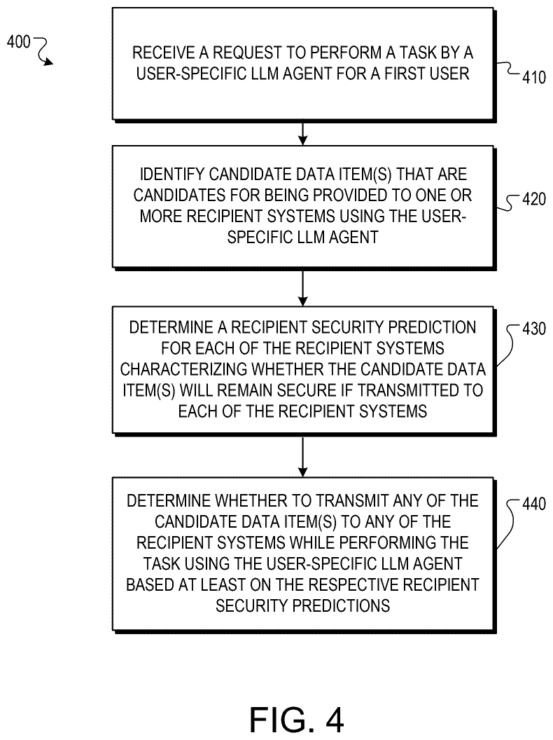

FIG. 4 is a flow diagram of an example process for determining whether to transmit one or more candidate data items to a recipient system while performing a task using a user-specific agent neural network. For convenience, the process 400 will be described as being performed by a system of one or more computers located in one or more locations. For example, a user-specific agent data security management system, e.g., the user-specific agent data security management system 200 of FIG. 2, appropriately programmed in accordance with this specification, can perform the process 400.

The system can receive a request to perform a task by a user-specific agent neural network (step 410), e.g., the user-specific agent neural network of a first user. As an example, the task can involve booking a hotel, shopping online, scheduling a meeting, or automating responses to emails.

The system can identify one or more candidate data items that are candidates for being provided to one or more recipient systems as part of performing the task (step 420). In particular, the system can process a first input including the request using the user-specific agent neural network with an instruction to identify one or more candidate data items and one or more recipient systems that are relevant for the task. For example, the user-specific agent neural network can access one or more candidate data items of the first user from a data repository, e.g., a database of first user information, and can process an instruction to identify (i) the one or more recipient systems that would be involved in fulfilling the request and (ii) the one or more candidate data items that are relevant to provide to each identified recipient system while performing the task. In some cases, the one or more recipient systems can be identified from a maintained registry of recipient systems. As another example, the system can receive identified candidate data items and potential recipient systems, e.g., from a different system.

The system can determine a recipient security prediction for each of the recipient systems characterizing whether the one or more candidate data items will remain secure if transmitted to each of the recipient systems as part of performing the task (step 430). For example, the system can process a second input including the one or more candidate data items and data characterizing the recipient system using the user-specific agent neural network with an instruction to identify any additional recipient systems that would receive the one or more candidate data items.

More specifically, the system can instruct the user-specific agent neural network to identify a sequence of recipient systems including the recipient system and any additional recipient systems up to a critical degree of separation based on a predicted first transmission between the recipient system and a first additional recipient system. In some cases, the second input can additionally include historical transmission data that specifies previous transmissions of candidate data items.

As an example, the system can iteratively use the user-specific agent neural network to process one or more second inputs for each first identified recipient system to identify the sequence of recipient systems based on how the one or more candidate data items would be managed by the potential recipient system. For example, the instructions can include (i) an identification of the first additional recipient system as a sending system, e.g., the recipient system, (ii) an identification of a second additional recipient system as a potential receiving system, e.g., the first additional recipient system, and (iii) an indication of why the one or more candidate data items would be transmitted from the sending system to the potential receiving system with an instruction to identify a third additional recipient system in the sequence of recipient systems. The system can use the identified sequence of recipient systems to construct an information flow graph, e.g., data representing a graph that characterizes the predicted first transmission between the recipient system and a first additional recipient system and any additional transmissions of the one or more candidate data items between additional recipient systems.

In the case that the recipient system includes a second user-specific agent neural network or at least one of the additional recipient systems include a second user-specific agent neural network, the system can recursively prompt the recipient system to identify the next system, e.g., the third additional system, in the sequence of recipient systems. More specifically, the system can process a third input using the second user-specific agent neural network including an instruction to identify the third additional recipient system that the second user-specific agent neural network would transmit the one or more candidate data items to in order to identify the next system in the sequence of recipient systems. In the case that the next system is a user-specific agent neural network, the system can process the third input using the next system to identify another next system, and so on.

Furthermore, the system can instruct the user-specific agent neural network to determine how sensitive each of the candidate data items are and whether it is reasonable to transmit the candidate data items with the one or more recipient systems based on the task. In particular, the system can determine a respective measure of sensitivity for each of the candidate data items by processing the candidate data item using the user-specific agent neural network with an instruction to quantify a security risk of transmitting the data item in general, e.g., to any of the one or more recipient systems, and can use the respective measures of sensitivity to determine the recipient security predictions. In some cases, the system can additionally process data contextualizing the task using the user-specific agent neural network with the instruction to quantify the security risk, e.g., since the measure of sensitivity for a candidate data item can depend on the context.

In particular, the system can determine a critical degree of separation value between the user-specific agent neural network and a final recipient system in the identified sequence of recipient systems using the respective measures of sensitivity for the one or more candidate data items. As an example, the system can process a model input including the respective measures of sensitivity, and in some cases, data contextualizing the task, using a degree of separation prediction machine learning model to generate a critical degree of separation value, e.g., the number of recipient systems in the sequence of recipient systems that the user-specific agent neural network should evaluate to ensure the security of the candidate data items after transmitting the candidate data items to a recipient system.

In particular, the critical degree of separation value can be a larger value for higher respective measures of sensitivity than the critical degree of separation for lower respective measures of security, e.g., when the candidate data items are more sensitive, the system can continue to instruct the user-specific agent neural network to evaluate any transmissions to additional recipient systems in order to ensure the candidate data items'security over a greater degree of separation.

The system can then determine whether to transmit any of the one or more candidate data items to any of the recipient systems while performing the task using the user-specific agent neural network based at least on the respective recipient security predictions (step 440). In particular, the system can determine to transmit none, a subset, or all of the candidate data items. For example, the system can use the information flow graph to identify a preferable path defined by a particular sequence of recipient systems using historical transmission data. In this case, the historical transmission data can specify the previous transmission of candidate data items between recipient systems and the system can identify a preferable path of recipient systems that have not previously transmitted data items in a security breach.

In some cases, the system can use the information flow graph to evaluate the worst possible outcome of transmitting the candidate data items to a particular recipient system, e.g., a security breach. For example, in the case that one of the identified recipient systems in the sequence of recipients is deemed untrustworthy or has previously transmitted personal data that led to a security breach, the system can compare this worst possible outcome to a threshold criterion characterizing an allowable worst possible outcome. In particular, the threshold criterion can be a more stringent for more sensitive candidate data items, e.g., the system can require that none of the identified recipient systems in the sequence of recipient systems have previously led to a security breach in the case that an extremely sensitive candidate data item would be transmitted with the recipient system.

Additionally, the system can determine a measure of reasonableness, e.g., a reasonableness score or a binary indicator, as part of determining the recipient security prediction. In this case, the system can process a fourth input that includes (i) the identification of a sending system, (ii) an identification of a receiving system, (iii) an indication of why the one or more candidate data items would be transmitted from the sending system to the receiving system, and (iv) how the one or more candidate data items would be managed by the receiving system with an instruction to determine whether how the one or more candidate data items would be managed by the receiving system is reasonable using the user-specific agent neural network of the first user to generate the measure of reasonableness.

In this case, the system can determine whether the measure of reasonableness satisfies a threshold criterion, and, in the case that the measure of reasonableness satisfies the threshold criteria, the system can determine to transmit any of the one or more candidate data items to any of the recipient systems. For example, the measure of reasonableness can be a reasonable score or a binary indicator for each of the one or more candidate data items and the threshold criterion can include respective threshold criteria values for each of the one or more candidate data items that depends on the respective measures of sensitivity for the respective candidate data items. As another example, the threshold criteria values can be learned.

In some cases, the system can determine to remove at least one of the candidate data items using the user-specific agent neural network, or can instruct the one or more recipient systems to not transmit at least one of the candidate data items with any additional recipient systems using the user-specific agent neural network. In the case of removing at least one of the candidate data items, the system can process an instruction to identify any candidate data items from the one or more candidate data items that can be redacted in accordance with the respective measure of sensitivity for the candidate data item.

In another case, the system can determine to not transmit any of the one or more candidate data items with any of the one or more recipient systems. In this case, the system can instruct the user-specific agent neural network to identify one or more other recipient systems that are relevant to completing the task, e.g., and repeat the steps 420-440 to evaluate whether to transmit any of the one or more candidate data items with the additionally identified relevant recipient systems.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving, by a user-specific agent neural network for a first user, a request to perform a task;
identifying one or more candidate data items that are candidates for being provided to one or more recipient systems while performing the task by processing a first input comprising the request using the user-specific agent neural network;
for each of the recipient systems, determining a recipient security prediction characterizing whether the one or more candidate data items will remain secure if transmitted to the recipient system as part of performing the task by processing a second input comprising the one or more candidate data items and data characterizing the recipient system using the user-specific agent neural network; and
based at least on the respective recipient security predictions, determining whether to transmit any of the one or more candidate data items to any of the recipient systems while performing the task using the user-specific agent neural network.

Embodiment 2 is the method of embodiment 1, wherein identifying one or more candidate data items that are candidates for being provided to one or more recipient systems while performing the task by processing the first input using the user-specific agent neural network comprises:
accessing one or more candidate data items of the first user from a data repository; and processing the first input using the user-specific agent neural network with an instruction to identify (i) the one or more recipient systems that would be involved in fulfilling the request and (ii) one or more candidate data items that are relevant to provide to each identified recipient system while performing the task.

Embodiment 3 is the method of any one of embodiments 1-2, wherein determining the recipient security prediction for each of the recipient systems by processing the second input using the user-specific agent neural network comprises:
processing the second input using the user-specific agent neural network with an instruction to identify a sequence of recipient systems comprising the recipient system and any additional recipient systems that would receive the one or more candidate data items up to a critical degree of separation based on a predicted first transmission between the recipient system and a first additional recipient system.

Embodiment 4 is the method of embodiment 3, wherein processing the second input with the instruction to identify the sequence of recipient systems further comprises:
processing one or more second inputs for each first additional recipient system in the sequence of recipient systems using the user-specific agent neural network, wherein each second input comprises: (i) an identification of the first additional recipient system as a sending system, (ii) an identification of a second additional recipient system as a potential receiving system, and (iii) an indication of why the one or more candidate data items would be transmitted from the sending system to the potential receiving system with an instruction to identify a third additional recipient system in the sequence of recipient systems based on how the one or more candidate data items would be managed by the potential receiving system; and
generating data representing a graph that characterizes the predicted first transmission between the recipient system and a first additional recipient system and any additional transmissions of the one or more candidate data items of the first user using the identified sequence of recipient systems.

Embodiment 5 is the method of any one of embodiments 3-4, wherein at least one additional recipient system is a second user-specific agent neural network, and wherein identifying the third additional recipient system in the sequence of recipient systems comprises: determining the third additional recipient system by processing a third input comprising the one or more candidate data items with an instruction to identify the third additional recipient system that the one or more candidate data items would be transmitted to using the second user-specific agent neural network.

Embodiment 6 is the method of any one of embodiments 1-5, further comprising:
for each of the one or more candidate data items, determining a respective measure of sensitivity by processing the candidate data item using the user-specific agent neural network with an instruction to quantify a security risk of transmitting the data item to the one or more recipient systems; and
determining the recipient security predictions for the one or more recipient systems using the respective measures of sensitivity.

Embodiment 7 is the method of embodiment 6, wherein determining the recipient security predictions using the respective measures of sensitivity further comprises:
determining a critical degree of separation value between the user-specific agent neural network and a final recipient system using the respective measures of sensitivity for the one or more candidate data items.

Embodiment 8 is the method of embodiment 7, wherein determining the critical degree of separation value using the respective measures of sensitivity comprises:
generating a critical degree of separation value by processing a model input comprising the respective measures of sensitivity using a degree of separation prediction machine learning model.

Embodiment 9 is the method of any one of embodiments 7-8, wherein the critical degree of separation value is a larger value for a first higher respective measures of sensitivity than the critical degree of separation value is for lower respective measures of sensitivity.

Embodiment 10 is the method of any one of embodiments 1-9, wherein the second input further comprises historical transmission data specifying previous transmissions of candidate data items from a plurality of recipient systems, and wherein determining whether to transmit any of the one or more candidate data items to any of the recipient systems while performing the task further using the user-specific agent neural network comprises:
identifying a particular recipient system from the one or more recipient systems to receive the one or more candidate data items in accordance with the historical transmission data.

Embodiment 11 is the method of embodiment 10, when dependent on embodiment 4, wherein identifying the preferable recipient system comprises identifying a preferable path in the graph defined by a particular sequence of recipient systems in accordance with the historical transmission data.

Embodiment 12 is the method of any one of embodiments 1-11, wherein determining whether to transmit any of the one or more candidate data items to any of the recipient systems while performing the task based at least on the respective recipient security predictions comprises:
determining a measure of reasonableness for transmitting any of the one or more candidate data items to a first recipient system by processing a fourth input comprising: (i) the identification of a sending system, (ii) an identification of a receiving system, (iii) an indication of why the one or more candidate data items would be transmitted from the sending system to the receiving system, and (iv) how the one or more candidate data items would be managed by the receiving system with an instruction to determine whether how the one or more candidate data items would be managed by the recipient system is reasonable using the user-specific agent neural network of the first user; and
determining whether the measure of reasonableness satisfies a threshold criterion.

Embodiment 13 is the method of embodiment 12, further comprising:
in response to determining that the measure of reasonableness satisfies the threshold criterion, transmitting any of the one or more candidate data items to any of the recipient systems.

Embodiment 14 is the method of any one of embodiments 12-13, wherein the measure of reasonableness is a reasonableness score for each of the one or more candidate data items.

Embodiment 15 is the method of any one of embodiments 12-13, wherein the measure of reasonableness is a binary indicator for each of the one or more candidate data items.

Embodiment 16 is the method of any one of embodiments 12-15, when dependent on claim 6, wherein determining whether the measure of reasonableness satisfies the threshold criterion comprises:
comparing the measure of reasonableness for each of the one or more candidate data items to a respective threshold criterion value, wherein the threshold criterion value depends on the respective measure of sensitivity for a respective candidate data item.

Embodiment 17 is the method of any one of embodiments 1-16, wherein determining whether to transmit the one or more candidate data items with any of the one or more recipient systems comprises:
removing at least one of the candidate data items using the user-specific agent neural network; or
instructing the one or more recipient systems to not transmit at least one of the data items with any additional recipient systems using the user-specific agent neural network.

Embodiment 18 is the method of embodiment 17, wherein removing at least one of the candidate data items using the user-specific agent neural network comprises:
processing the candidate data items using the user-specific agent neural network with an instruction to identify any candidate data items from the one or more candidate data items to redact in accordance with the respective measure of sensitivity for the candidate data item.

Embodiment 19 is the method of any one of embodiments 1-18, further comprising:
determining to not transmit any of the one or more candidate data items with any of the one or more recipient systems; and
in response to determining to not transmit any of the one or more candidate data items with any of the one or more recipient systems, processing an instruction using the user-specific agent neural network to identify one or more other recipient systems.

Embodiment 20 is the method of any one of embodiments 1-19, and wherein at least one of the one or more recipient systems is a second user-specific agent.

Embodiment 21 is the method of embodiment 20, wherein the user-specific agent neural network of the first user and the second user-specific agent neural network of the at least one or more recipient systems have been finetuned by operations comprising, for each user-specific agent neural network:
receiving input data comprising task characterization data and a ground truth indication of transmitting any of the one or more candidate data items to any of the one or more recipient systems;

receiving one or more prompts in a chain-of-thought prompting framework comprising
receiving consecutive instructions to determine one or more relevant agents as recipient systems for the request, identify one or more candidate data items requested by the one or more recipient systems, determine how the one or more candidate data items would be transmitted by the one or more recipient systems, determine whether how the one or more candidate data items would be transmitted by the recipient system is reasonable, and determine whether to transmit the one or more candidate data items based on how the one or more candidate data items would be transmitted;
updating one or more parameter values of a set of parameters of the user-specific agent neural network based at least on a discrepancy between the user-specific agent neural network determination of transmitting any of the one or more candidate data items to any of the one or more recipient systems and the ground truth indication of transmitting any of the one or more candidate data items to any of the one or more recipient systems.

Embodiment 22 is the method of embodiment 20, wherein the user-specific agent neural network of the first user and the second user-specific agent neural network of the at least one or more recipient systems have been finetuned by operations comprising, for each user-specific agent neural network:
receiving input data comprising task characterization data;
receiving consecutive instructions to determine one or more relevant agents as recipient systems for the request, identify one or more candidate data items requested by the one or more recipient systems, determine how the one or more candidate data items would be transmitted by the one or more recipient systems, determine whether how the one or more candidate data items would be transmitted by the recipient system is reasonable, and determine whether to transmit the one or more candidate data items based on how the one or more candidate data items would be transmitted;
updating one or more parameter values of a set of parameters of the user-specific agent neural network based at least on a reward received for responses generated by the user-specific agent neural network to the one or more prompts received in the chain-of-thought-prompting framework.

Embodiment 23 is the method of any one of embodiments 21-22, further comprising:
generating at least one embedding of at least one element of the input data using respective element encoder models, wherein the at least one element of the input data comprises the task characterization data and the at least one embedding comprises a task embedding; and
jointly updating one or more parameter values of a set of parameters of the respective element encoder models with the set of parameters of the user-specific agent neural network.

Embodiment 24 is the method of embodiment 23, further comprising:
comparing the task embedding to a plurality of maintained task embeddings, wherein each maintained task embedding is associated with a corresponding result from transmitting any of the one or more candidate data items to any of the one or more recipient systems;
identifying a set of one or more maintained task embeddings within a threshold discrepancy in accordance with a similarity criterion; and
determining whether to transmit any of the one or more candidate data items with any of the one or more recipient systems by processing a few-shot prompt comprising the identified set of one or more maintained request embeddings and respective associated corresponding results using the user-specific agent neural network.

Embodiment 25 is the method of any one of embodiments 1-24, wherein the one or more recipient systems have been identified from a registry of recipient systems.

Embodiment 26 is a system comprising: one or more computers and one or more storage devices storing instructions that are operable, when executed by the one or more computers, to cause the one or more computers to perform the method of any one of embodiments 1 to 25.

Embodiment 27 is a computer storage medium encoded with a computer program, the program comprising instructions that are operable, when executed by data processing apparatus, to cause the data processing apparatus to perform the method of any one of embodiments 1 to 25.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving, by a user-specific agent neural network for a first user, a request to perform a task;
identifying one or more candidate data items that are candidates for being provided to one or more recipient systems while performing the task by processing a first input comprising the request using the user-specific agent neural network;
for each of the recipient systems, determining a recipient security prediction characterizing whether the one or more candidate data items will remain secure if transmitted to the recipient system as part of performing the task by processing a second input comprising the one or more candidate data items and data characterizing the recipient system using the user-specific agent neural network; and
based at least on the respective recipient security predictions, determining whether to transmit any of the one or more candidate data items to any of the recipient systems while performing the task using the user-specific agent neural network.

2. The method of claim 1, wherein identifying one or more candidate data items that are candidates for being provided to one or more recipient systems while performing the task by processing the first input using the user-specific agent neural network comprises:
accessing one or more candidate data items of the first user from a data repository; and
processing the first input using the user-specific agent neural network with an instruction to identify (i) the one or more recipient systems that would be involved in fulfilling the request and (ii) one or more candidate data items that are relevant to provide to each identified recipient system while performing the task.

3. The method of claim 1, wherein determining the recipient security prediction for each of the recipient systems by processing the second input using the user-specific agent neural network comprises:
processing the second input using the user-specific agent neural network with an instruction to identify a sequence of recipient systems comprising the recipient system and any additional recipient systems that would receive the one or more candidate data items up to a critical degree of separation based on a predicted first transmission between the recipient system and a first additional recipient system.

4. The method of claim 3, wherein processing the second input with the instruction to identify the sequence of recipient systems further comprises:
processing one or more second inputs for each first additional recipient system in the sequence of recipient systems using the user-specific agent neural network, wherein each second input comprises: (i) an identification of the first additional recipient system as a sending system, (ii) an identification of a second additional recipient system as a potential receiving system, and (iii) an indication of why the one or more candidate data items would be transmitted from the sending system to the potential receiving system with an instruction to identify a third additional recipient system in the sequence of recipient systems based on how the one or more candidate data items would be managed by the potential receiving system; and
generating data representing a graph that characterizes the predicted first transmission between the recipient system and a first additional recipient system and any additional transmissions of the one or more candidate data items of the first user using the identified sequence of recipient systems.

5. The method of claim 3, wherein at least one additional recipient system is a second user-specific agent neural network, and wherein identifying the third additional recipient system in the sequence of recipient systems comprises:
determining the third additional recipient system by processing a third input comprising the one or more candidate data items with an instruction to identify the third additional recipient system that the one or more candidate data items would be transmitted to using the second user-specific agent neural network.

6. The method of claim 1, further comprising:
for each of the one or more candidate data items, determining a respective measure of sensitivity by processing the candidate data item using the user-specific agent neural network with an instruction to quantify a security risk of transmitting the data item to the one or more recipient systems; and
determining the recipient security predictions for the one or more recipient systems using the respective measures of sensitivity.

7. The method of claim 6, wherein determining the recipient security predictions using the respective measures of sensitivity further comprises:
determining a critical degree of separation value between the user-specific agent neural network and a final recipient system using the respective measures of sensitivity for the one or more candidate data items.

8. The method of claim 7, wherein determining the critical degree of separation value using the respective measures of sensitivity comprises:
generating a critical degree of separation value by processing a model input comprising the respective measures of sensitivity using a degree of separation prediction machine learning model.

9. The method of claim 7, wherein the critical degree of separation value is a larger value for a first higher respective measures of sensitivity than the critical degree of separation value is for lower respective measures of sensitivity.

10. The method of claim 1, wherein the second input further comprises historical transmission data specifying previous transmissions of candidate data items from a plurality of recipient systems, and wherein determining whether to transmit any of the one or more candidate data items to any of the recipient systems while performing the task further using the user-specific agent neural network comprises:
identifying a particular recipient system from the one or more recipient systems to receive the one or more candidate data items in accordance with the historical transmission data.

11. The method of claim 10, wherein identifying the preferable recipient system comprises identifying a preferable path in a graph that characterizes a predicted first transmission between the recipient system and a first additional recipient system and any additional transmissions of the one or more candidate data items of the first user, wherein the preferable path in the graph is defined by a particular sequence of recipient systems in accordance with the historical transmission data.

12. The method of claim 1, wherein determining whether to transmit any of the one or more candidate data items to any of the recipient systems while performing the task based at least on the respective recipient security predictions comprises:
determining a measure of reasonableness for transmitting any of the one or more candidate data items to a first recipient system by processing a fourth input comprising: (i) the identification of a sending system, (ii) an identification of a receiving system, (iii) an indication of why the one or more candidate data items would be transmitted from the sending system to the receiving system, and (iv) how the one or more candidate data items would be managed by the receiving system with an instruction to determine whether how the one or more candidate data items would be managed by the recipient system is reasonable using the user-specific agent neural network of the first user; and
determining whether the measure of reasonableness satisfies a threshold criterion.

13. The method of claim 12, further comprising:
in response to determining that the measure of reasonableness satisfies the threshold criterion, transmitting any of the one or more candidate data items to any of the recipient systems.

14. The method of claim 12, wherein the measure of reasonableness is a reasonableness score for each of the one or more candidate data items.

15. The method of claim 12, wherein the measure of reasonableness is a binary indicator for each of the one or more candidate data items.

16. The method of claim 12, wherein determining whether the measure of reasonableness satisfies the threshold criterion comprises:
comparing the measure of reasonableness for each respective candidate data item of the one or more candidate data items to a respective threshold criterion value, wherein each respective threshold criterion value depends on a respective measure of sensitivity that quantifies a security risk of transmitting the respective candidate data item to the one or more recipient systems.

17. The method of claim 1, wherein determining whether to transmit the one or more candidate data items with any of the one or more recipient systems comprises:
removing at least one of the candidate data items using the user-specific agent neural network; or
instructing the one or more recipient systems to not transmit at least one of the data items with any additional recipient systems using the user-specific agent neural network.

18. The method of claim 17, wherein removing at least one of the candidate data items using the user-specific agent neural network comprises:
processing the candidate data items using the user-specific agent neural network with an instruction to identify any candidate data items from the one or more candidate data items to redact in accordance with the respective measure of sensitivity for the candidate data item.

19. The method of claim 1, further comprising:
determining to not transmit any of the one or more candidate data items with any of the one or more recipient systems; and
in response to determining to not transmit any of the one or more candidate data items with any of the one or more recipient systems, processing an instruction using the user-specific agent neural network to identify one or more other recipient systems.

20. The method of claim 1, and wherein at least one of the one or more recipient systems is a second user-specific agent.

21. The method of claim 20, wherein the user-specific agent neural network of the first user and the second user-specific agent neural network of the at least one or more recipient systems have been finetuned by operations comprising, for each user-specific agent neural network:
receiving input data comprising task characterization data and a ground truth indication of transmitting any of the one or more candidate data items to any of the one or more recipient systems;
receiving one or more prompts in a chain-of-thought prompting framework comprising receiving consecutive instructions to determine one or more relevant agents as recipient systems for the request, identify one or more candidate data items requested by the one or more recipient systems, determine how the one or more candidate data items would be transmitted by the one or more recipient systems, determine whether how the one or more candidate data items would be transmitted by the recipient system is reasonable, and determine whether to transmit the one or more candidate data items based on how the one or more candidate data items would be transmitted;
updating one or more parameter values of a set of parameters of the user-specific agent neural network based at least on a discrepancy between the user-specific agent neural network determination of transmitting any of the one or more candidate data items to any of the one or more recipient systems and the ground truth indication of transmitting any of the one or more candidate data items to any of the one or more recipient systems.

22. The method of claim 20, wherein the user-specific agent neural network of the first user and the second user-specific agent neural network of the at least one or more recipient systems have been finetuned by operations comprising, for each user-specific agent neural network:
receiving input data comprising task characterization data;
receiving consecutive instructions to determine one or more relevant agents as recipient systems for the request, identify one or more candidate data items requested by the one or more recipient systems, determine how the one or more candidate data items would be transmitted by the one or more recipient systems, determine whether how the one or more candidate data items would be transmitted by the recipient system is reasonable, and determine whether to transmit the one or more candidate data items based on how the one or more candidate data items would be transmitted;
updating one or more parameter values of a set of parameters of the user-specific agent neural network based at least on a reward received for responses generated by the user-specific agent neural network to the one or more prompts received in the chain-of-thought-prompting framework.

23. The method of claim 21, further comprising:
generating at least one embedding of at least one element of the input data using respective element encoder models, wherein the at least one element of the input data comprises the task characterization data and the at least one embedding comprises a task embedding; and
jointly updating one or more parameter values of a set of parameters of the respective element encoder models with the set of parameters of the user-specific agent neural network.

24. The method of claim 23, further comprising:
comparing the task embedding to a plurality of maintained task embeddings, wherein each maintained task embedding is associated with a corresponding result from transmitting any of the one or more candidate data items to any of the one or more recipient systems;
identifying a set of one or more maintained task embeddings within a threshold discrepancy in accordance with a similarity criterion; and
determining whether to transmit any of the one or more candidate data items with any of the one or more recipient systems by processing a few-shot prompt comprising the identified set of one or more maintained request embeddings and respective associated corresponding results using the user-specific agent neural network.

25. The method of claim 1, wherein the one or more recipient systems have been identified from a registry of recipient systems.

26. A system comprising one or more computers and one or more storage devices storing instructions that are operable, when executed by the one or more computers, to cause the one or more computers to perform operations comprising:
receiving, by a user-specific agent neural network for a first user, a request to perform a task;
identifying one or more candidate data items that are candidates for being provided to one or more recipient systems while performing the task by processing a first input comprising the request using the user-specific agent neural network;
for each of the recipient systems, determining a recipient security prediction characterizing whether the one or more candidate data items will remain secure if transmitted to the recipient system as part of performing the task by processing a second input comprising the one or more candidate data items and data characterizing the recipient system using the user-specific agent neural network; and
based at least on the respective recipient security predictions, determining whether to transmit any of the one or more candidate data items to any of the recipient systems while performing the task using the user-specific agent neural network.

27. A computer storage medium encoded with a computer program, the program comprising instructions that are operable, when executed by data processing apparatus, to cause the data processing apparatus to perform operations comprising:
receiving, by a user-specific agent neural network for a first user, a request to perform a task;
identifying one or more candidate data items that are candidates for being provided to one or more recipient systems while performing the task by processing a first input comprising the request using the user-specific agent neural network;
for each of the recipient systems, determining a recipient security prediction characterizing whether the one or more candidate data items will remain secure if transmitted to the recipient system as part of performing the task by processing a second input comprising the one or more candidate data items and data characterizing the recipient system using the user-specific agent neural network; and
based at least on the respective recipient security predictions, determining whether to transmit any of the one or more candidate data items to any of the recipient systems while performing the task using the user-specific agent neural network.
